(19) United States
(12) Patent Application Publication
(10) Pub. No.: US 2014/0266916 A1
(43) Pub. Date: Sep. 18, 2014

(54) METHOD AND APPARATUS FOR DETERMINING LOCATIONS OF ACCESS POINTS

(71) Applicant: QUALCOMM INCORPORATED, San Diego, CA (US)

(72) Inventors: Payam Pakzad, Mountain View, CA (US); Sina Firouzabadi, Sunnyvale, CA (US)

(73) Assignee: QUALCOMM INCORPORATED, San Diego, CA (US)

(21) Appl. No.: 13/800,437

(22) Filed: Mar. 13, 2013

(51) Int. Cl. G01S 5/02

(52) U.S. Cl. CPC G01S 5/0289
USPC 342/464

(57) ABSTRACT

Methods and apparatuses for determining locations of a plurality of access points (APs) are presented. In some embodiments, the method includes obtaining measurements from at least 3 measurement points using a mobile device, wherein the locations of the at least 3 measurement points are unknown and are at different locations. The method may also include computing distance measurements from the mobile device to each of the plurality of APs, at each of the at least 3 measurement points, using the measurements, computing a set of mutual distance values in a matrix of mutual distances between each of the plurality of APs, using the distance measurements, and determining the locations of the plurality of APs using the computed matrix of mutual distances, relative to the at least 3 measurement points.

### BACKGROUND

Fingerprinting may be known as a technique for methodically recording ranging information about access points in order to determine the locations of the access points (APs). Fingerprinting may involve recording a comprehensive account of the ranging information of each AP within a set radius at every location (e.g. every (x,y) location) in a grid around the APs. However, as APs become more ubiquitous, determining their locations may be more and more cumbersome using known fingerprinting techniques. Thus, there may be a need to develop quicker and more efficient methods for reliably determining locations of APs.

### SUMMARY

These problems and others may be solved according to various embodiments, described herein.

In some embodiments, a method for determining locations of a plurality of access points (APs) is presented. The method may include a) obtaining measurements from at least 3 measurement points using a mobile device, wherein the locations of the at least 3 measurement points are unknown and are at different locations; b) computing distance measurements from the mobile device to each of the plurality of APs, at each of the at least 3 measurement points, using the measurements; c) computing a set of mutual distance values in a matrix of mutual distances between each of the plurality of APs, using the distance measurements; and d) determining the locations of the plurality of APs using the computed matrix of mutual distances, relative to the at least 3 measurement points.

In some embodiments, the at least 3 measurement points include 3 reference points whose locations are unambiguously determined. The method may further include e) determining global locations of the plurality of APs using the computed matrix of mutual distances and the 3 reference points.

In some embodiments, the measurements from each of the at least 3 measurements points include ranging information associated with each of the plurality of APs. In some embodiments, the measurements include WiFi measurements.

In some embodiments, computing the distance measurements includes at least one of computing roundtrip times from the mobile device to each of the APs, and estimating the distance measurements based on signal strength to each of the APs from the mobile device.

In some embodiments, a measurement point of the at least 3 measurement points having a strongest measurement among the measurements is determined to be an actual location of one of the plurality of APs.

In some embodiments, the method may further include repeating steps a) through d) in an iterative process, wherein the measurements obtained in step a) are based on the determined locations of the plurality of APs in step d).

In some embodiments, an apparatus for determining locations of a plurality of access points (APs) is presented. The apparatus may include a receiver configured to obtain measurements from at least 3 measurement points using a mobile device, wherein the locations of the at least 3 measurement points are unknown and are at different locations. The apparatus may also include a processor configured to: compute distance measurements from the mobile device to each of the plurality of APs, at each of the at least 3 measurement points, using the measurements; compute a set of mutual distance values in a matrix of mutual distances between each of the plurality of APs, using the distance measurements; and determine the locations of the plurality of APs using the computed matrix of mutual distances, relative to the at least 3 measurement points.

In some embodiments, an apparatus for determining locations of a plurality of access points (APs) is presented. The apparatus may include means for obtaining measurements from at least 3 measurement points, wherein the locations of the at least 3 measurement points are unknown and are at different locations. The apparatus may also include means for computing distance measurements from the apparatus to each of the plurality of APs, at each of the at least 3 measurement points, using the measurements; means for c) computing a set of mutual distance values in a matrix of mutual distances between each of the plurality of APs, using the distance measurements; and means for d) determining the locations of the plurality of APs using the computed matrix of mutual distances, relative to the at least 3 measurement points.

In some embodiments, a non-transitory processor-readable medium comprising processor-readable instructions is presented. The non-transitory process-readable medium may be configured to cause a processor to: obtain measurements from at least 3 measurement points, wherein the locations of the at least 3 measurement points are unknown and are at different locations; b) compute distance measurements from a mobile device to each of a plurality of APs, at each of the at least 3 measurement points, using the measurements; c) compute a set of mutual distance values in a matrix of mutual distances between each of the plurality of APs, using the distance measurements; and d) determine the locations of the plurality of APs using the computed matrix of mutual distances, relative to the at least 3 measurement points.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is an example wireless environment showing an access point (AP) according to some embodiments.

FIG. 2 is an example wireless communications interface including a transmitter system and a receiver system according to some embodiments.

FIG. 3A is an example scenario employing methods of some embodiments in an office building environment with multiple access points.

FIG. 3B is an example illustration of results employing methods according to some embodiments.

FIG. 4 is an example mathematical process used in implementations according to some embodiments.

FIGS. 5A and 5B are exemplary flowcharts showing methods of some embodiments.

FIG. 6 is an example computer system according to some embodiments.

### DETAILED DESCRIPTION

The word “exemplary” is used herein to mean “serving as an example, instance, or illustration.” Any embodiment or design described herein as “exemplary” is not necessarily to be construed as preferred or advantageous over other embodiments or designs.

As used herein, an “access point” may refer to any device capable of and/or configured to route, connect, share, and/or otherwise provide a network connection to one or more other devices. An access point may include one or more wired and/or wireless interfaces, such as one or more Ethernet interfaces and/or one or more IEEE 802.11 interfaces, respectively, via which such a connection may be provided. For example, an access point, such as a wireless router, may include one or more Ethernet ports to connect to a local modem or other network components (e.g., switches, gateways, etc.) and/or to connect to one or more other devices to which network access is to be provided, as well as one or more antennas and/or wireless networking cards to broadcast, transmit, and/or otherwise provide one or more wireless signals to facilitate connectivity with one or more other devices. Other examples of access points may include a femto cell or wireless beacon.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA2000, etc. UTRA includes Wideband-CDMA (W-CDMA) and Low Chip Rate (LCR). CDMA2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA is part of Universal Mobile Telecommunication System (UMTS). Long Term Evolution (LTE) uses E-UTRA. UTRA, E-UTRA, GSM, UMTS and LTE are described in documents from 3GPP. CDMA2000 is described in documents from an organization named “3rd Generation Partnership Project 2” (3GPP2). These various radio technologies and standards are known in the art.

Single carrier frequency division multiple access (SC-FDMA), which utilizes single carrier modulation and frequency domain equalization is a technique. SC-FDMA may have similar performance and overall complexity as those of OFDMA system. SC-FDMA signal may have lower peak-to-average power ratio (PAPR) because of its inherent single carrier structure. SC-FDMA has drawn great attention, especially in the uplink communications where lower PAPR greatly benefits the mobile terminal in terms of transmit power efficiency. It is currently a working assumption for uplink multiple access scheme in 3GPP Long Term Evolution (LTE), or Evolved UTRA.

Methods for identifying locations of WiFi access points (APs) by obtaining a subset of a full WiFi measurement fingerprinting map and without needing to perform the full WiFi fingerprinting campaign, are presented. The techniques presented herein may more efficiently determine the locations of APs used for indoor positioning and the like by sampling just a few WiFi measurements of relative distances/signal strengths from the APs to a mobile device, for example.

Indoor positioning may rely on knowledge of the locations of APs to make appropriate WiFi positioning models, and thus the locations of the APs must be known accurately. Examples of APs may be wireless routers emitting a WiFi signal having various strengths and being in various locations, e.g. in the corner of a room, on a bookshelf, in a closet, etc. Obtaining locations of APs may be difficult because the layouts showing the AP locations may be unavailable, outdated, or otherwise inaccurate. A traditional method for obtaining AP locations is to obtain WiFi measurements of every sector of the floor containing the APs, as if the floor were divided into a matrix of tiny sectors. Measurements to the APs at each sector could be obtained, and thereby the sectors with the strongest signals amongst all the measurements could be deemed to contain the APs. Such a technique is sometimes called fingerprinting. Traditional techniques like these are very cumbersome, requiring a user to take measurements at each sector of the floor. Additionally, traditional fingerprinting techniques require a priori knowledge of the location of the device taking the measurements. Such calculations may consume more time and power.

In contrast, according to some embodiments, a surveyor may obtain just a few measurements at just a few locations on the floor in order to make a determination as to the locations of all the APs on the floor. The locations of where the surveyor obtains such measurements do not have to be known in order for methods of various embodiments to succeed. In some embodiments, implementations may utilize principles of linear algebra and operations research, where the mutual distances from the surveyor (using a mobile device, for example) to the multiple APs may be expressed in a matrix (e.g. n×n matrix, where n is the number of APs on the floor). In a matrix like this, which is an example of a symmetric square matrix, based on linear algebra, it is determined that that a minimum of only 3 (non-colinear) measurement points, each measurement point containing a distance measurement to each AP in question, may be needed to obtain all of the mutual distance values in the matrix. In other words, by obtaining just a few measurement points, e.g. at least 3 that are non-colinear, aspects of various embodiments can determine the locations of all the APs on the floor.

Referring to FIG. 1, an example multiple-access access point utilized in some embodiments is presented. Access point (AP) 100 includes multiple antennas, including 104, 106, and 108. More or fewer antennas may be utilized in other embodiments. Examples of APs may include any wireless router, any device capable of employing a WiFi network, a hotspot, femtocell, WLAN, and the like. Access terminal 116 (AT) may be in communication with AP 100 via antenna 104, where antenna 104 may transmit signals to access terminal 116 over forward link 120 and may receive signals from access terminal 116 over reverse link 118. Forward link 120 and reverse link 118 may be based on common wireless interfaces as defined in any of the IEEE 802.11 standards, though this is just one example. Other air interfaces known in the art may be used, and embodiments are not so limited. Access terminal 122 is in communication with AP 100 via antenna 108, where antenna 108 may transmit signals to access terminal 122 over forward link 126 and may receive signals from access terminal 122 over reverse link 124. Example ATs may include mobile devices, mobile phones, tablets, laptop computers, PDAs, and the like. In a Frequency Division Duplex (FDD) system, communication links 118, 120, 124 and 126 may use different frequencies for communication. For example, forward link 120 may use a different frequency then that used by reverse link 118. In some embodiments, antennas 104, 106, and 108 may each be in communication with both ATs 116 and 122. AT 116 may be in communication with AP 100 in a first frequency, while AT 122 may be in communication with AP 100 in a second frequency, for example. In some embodiments, multiple antennas, e.g. antennas 104 and 106, may be in communication with just a single mobile device, e.g. AT 116. Multiple antennas may be used to transmit the same type of data but arranged in different sequences to improve diversity gain.

Each group of antennas and/or the area in which they are designed to communicate is often referred to as a sector of the access point. In some embodiments, antenna groups each are designed to communicate to access terminals in a sector of the areas covered by access point 100.

FIG. 2 is a block diagram of an embodiment of a transmitter system 210 (which may, for example, implement the access point 100) and a receiver system 250 (which may, for example, implement the mobile device 116 or 122) in a MIMO system 200. It should be noted however, that while an example MIMO system 200 is described, MIMO is not used in some embodiments, as other systems may be used (e.g. SISO, MISO, SIMO, etc.). At the transmitter system 210, traffic data for a number of data streams is provided from a data source 212 to a transmit (TX) data processor 214.

In some embodiments, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides NT modulation symbol streams to NT transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. NT modulated signals from transmitters 222a through 222t are then transmitted from NT antennas 224a through 224t, respectively.

At receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream. In some embodiments, media recorder 282 may also be included to receive various forms of digital media, including images, sounds, or text. This media may be processed through RX data processor 260 and processor 270, and ultimately stored in memory 272.

An RX data processor 260 then receives and processes the NR received symbol streams from NR receivers 254 based on a particular receiver processing technique to provide NT “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically may determine which pre-coding matrix to use. Processor 270 may formulate a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210. Two or more receiver, transmitter, and antenna groups may be configured to access separate networks, for example a WLAN network and an LTE, WCDMA, or cdma2000 HPRD network. In some embodiments, a single receiver, transmitter, and antenna group may be configured to access at least two separate networks. Similarly, a plurality of processors may be included to process communications and/or data for a plurality of networks. Further, a single processor may be configured to process communications and/or data for a plurality of networks.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message. In some embodiments, beamforming is not used.

Referring to FIG. 3A, exemplary office environment 300 provides an example implementation according to some embodiments. Here, office floor plan schematic 300 shows various rooms and hallways of one floor of an office building. The numbers on the horizontal and vertical axes may illustrate example distances measured in, for example, feet. Numbers shown in square boxes spread throughout floor plan 300, such as box 302 labeled “1” with hash marks, may represent where APs are located. As mentioned above, these APs may transmit and receive WiFi signals to a range of offices and hallways around their locations. The APs may transmit wireless signals according to various protocols, including any 802.11 IEEE standards, for example. In some embodiments, the APs also transmit round trip time (RTT) measurements). In some embodiments, the APs also transmit received signal strength indicator (RSSI) measurements. As shown in this example, sixteen APs are placed at various locations around floor plan 300, including for example, AP 304, labeled “8,” and AP 306, labeled “7.”

According to various embodiments, the locations of the APs may be determined in an efficient and accurate manner. The methods presented herein may be significantly quicker and less resource-intensive than traditional methods for determining APs locations, such as traditional fingerprinting methods. For example, a surveyor equipped with a mobile device may walk in a somewhat arbitrary fashion throughout floor plan 300. For example, the surveyor may start at location 308, walk to location 310, then finish by walking to location 312. Along the way, the surveyor may record ranging measurements from his present location to all of the APs, e.g. distance or timing measurements, at several locations. For example, the surveyor may record at location 308 measurements from location 308 to all of the APs, i.e. the boxes labeled “1” through “16.” For example, the surveyor may record sixteen different RTT measurements, one for each AP, at location 308. Then, the surveyor may do the same procedure at another location, for example location 310. For example, sixteen more RTT measurements may be obtained at location 310, one for each AP. Finally, the surveyor may record sixteen more RTT measurements at location 312, one for each AP. The surveyor may also record other ranging measurements to all of the APs along the way between locations 308, 310, and 312. It should be appreciated that no mention of the exact or precise location of locations 308, 310, and 312 were discussed. This is because in some embodiments, it is not necessary to know the locations of where the surveyor actually recorded the timing or distance measurements to each of the APs. In contrast, traditional methods of determining AP locations, such as in fingerprinting, may require that the locations of the surveyor be known. In some embodiments, more than the three locations described may be used to obtain more distance or timing measurements. These measurements may be helpful in obtaining even more accurate results, for example.

Referring to FIG. 3B, office floor plan 350 illustrates example results of the determined locations of the APs using the process described in FIG. 3A. For example, using just the measurements to each of the APs obtained by the surveyor at several locations, e.g. locations 308, 310, and 312, an estimate of all of the sixteen APs may be determined, as shown in floor plan 350. As before in FIG. 3A, the numbered boxes with single-lined hash marks may represent the actual locations of the APs, e.g. APs 356, 352, 358, and 354, etc. The numbered boxes with criss-crossed hash marks may represent the estimated locations, e.g. APs 352′, and 354′. As shown in this example, by utilizing as few as three locations of the surveyor taking measurements of all of the APs, methods and apparatuses according various embodiments may obtain fairly accurate positions of all sixteen APs in office floor plan 350. Again, measurements of all sixteen APs taken at many more locations may improve the accuracy of the estimated locations. In some embodiments, methods may first obtain exact positions of a few reference APs, such as APs 356, 358, and 360, in order to determine absolute locations of all sixteen APs (e.g. in order to fix the true geo-reference locations of the APs in the office floor plan). Because these locations may already be known, a duplicate estimate location of those APs may not be shown. In some embodiments, a location of the surveyor that reports the strongest/closest ranging measurement to an AP may be designated as the location of that particular AP. In these cases, these locations may be considered reference locations to help hone determinations of the locations of the other APs.

Referring to FIG. 4, an example mathematical illustration describes at least one process for implementing various embodiments. In this example, methods may rely on principles of linear algebra and/or operations research. For example, given n APs, an n×n matrix D of mutual distances between the n APs and arbitrary locations (e.g. locations 308, 310, and 312) may be generated. In language of linear algebra, it is known that matrix D has rank at most 4 irrespective of the size of n. Because of this, with a representative subset of known elements of D, e.g. some known mutual distances from the arbitrary locations to the locations of at least some of the APs, it is possible to solve for the entire matrix D, e.g. determine all of the other mutual distances between the arbitrary locations and the locations of all of the APs. One exception to be cautious of is when the arbitrary locations happen to be co-linear to each other, e.g. a combination of the locations creates a column or row in the matrix D that is merely a scalar multiple of another column or row. In other words, when there are at least three non-co-linear reference points, the positions of the n APs may be unambiguously resolved.

FIG. 4 shows one example illustrating these principles, which may be used in some embodiments. Illustration 400 shows a 4×4 matrix D, with 4 columns and 4 rows. Each of the sixteen entries may represent a mutual distance value from one location to another. Illustration 410 corresponds to example matrix 400, in that points {1, 2, 3, 4} represent the locations used in matrix D. That is, matrix D is organized such that the first column from the left shows the distance from point {1} in block 410 to points {1, 2, 3, 4}, respectively, from the top row down to the bottom row. For example, the distance from point 1 to point 2 is shown as “1,” while the distance from point 1 to point 4 is shown as “\sqrt{2}” And the distance from point 1 to itself is designated as “0.” Similarly, the second column from the left shows the distances from point 2 to points {1, 2, 3, 4}, respectively, from the top row down to the bottom row, and so forth. Thus, matrix D may be considered a 4×4 matrix of mutual distances.

It is known then that matrix D possesses properties such that all of the mutual distances may be resolved when only a subset of mutual distances are known. For example, assuming that point 2 is not on top of point 3, then with the following example known subset, the other values of D can be unambiguously determined:

Triangle 1-2-4 is uniquely determined
Triangle 1-3-4 is uniquely determined
Fixing edge 1-4, 2 and 3 are determined

The inclusion of the above mentioned constraints is reflected in matrix 420. As shown in this example, not all of the matrix values are yet known, but information from all of the known values are sufficient to determine the remaining unknown values. This simplistic example illustrates how methods according to some embodiments may be able to determine the remaining mutual distances between all locations, such as between all APs on a floor plan map. In this example, since it is known that an n×n matrix of mutual distances has at most rank 4, then at most, 4 non-co-linear constraints about at least some points in the n×n matrix need to be determined in order to determine the rest of the mutual distances, regardless of the size of n. An example of 4 constraints is shown in the preceding paragraph, which may be used to determine the unknown values in matrix 420, labeled as question marks.

Using the principles discussed in FIG. 4 as one example for determining numerous mutual distances with just a few known constraints, methods and apparatuses according to some embodiments may implement the following example algorithm:
Step 1: collect measurements across the venue; e.g. by attaching a WiFi logger to a surveyor and moving arbitrarily across the venue.
Step 2: correspond the points with strongest WiFi measurements to an AP i with the location of AP i
Step 3: estimate distances between APs i and j from the measurements to AP j at measurement points corresponding to AP i (can use average of multiple “corresponding points”)
Step 4: solve for the full matrix D of mutual distances between APs, and 3 given reference measurement points
Step 5: Fix the locations of APs and measurement points on map given 3 reference points (e.g. from GPS)

In this first example algorithm, Step 2 may designate several of the strongest WiFi measurements to an AP i as being located at or near AP i. Step 3 may then determine a set of distances to all other APs j from AP i. These distances may satisfy the several non-co-linear measurements needed to help determine the rest of the mutual distances, consistent with the descriptions in FIG. 4. Thus, Steps 2 and 3 may provide several reference measurements of mutual distances between APs. Then, at Step 4, the full matrix D of mutual distances may be determined, knowing the given reference measurements estimated at Steps 2 and 3. Finally, at Step 5, the absolute locations may be fixed by determining a few absolute locations; for example the locations of some reference APs or measurement points may be determined using GNSS or other means, and then the other absolute locations may be determined relative to those reference points.

In some embodiments, the locations of the APs may be determined using a different algorithm, as follows:
Step 1: collect measurements across the venue; e.g., by attaching a WiFi logger to a surveyor and moving arbitrarily across the venue.
Step 2: estimate the distances from each measurement point to each visible AP using a basic WiFi ranging model
Step 3: solve for the full matrix D of mutual distances between measurement points and APs
Step 4: Fix the locations of APs and measurement points on map given 3 reference points (e.g. from GPS)

Note that in this second example algorithm, the matrix D of mutual distances includes both AP locations and measurement points. In this case, distances between a measurement point i and an AP x are estimated from the direct WiFi measurement, whereas the distances between measurement points i and j may be estimated from odometry information such as a pedestrian dead-reckoning (PDR) system using inertial sensors on the measuring device, or by other means.

In general, the algorithms described herein include several common concepts. Specifically, at each of the at least 3 measurement points, measurements of WiFi signals are recorded from each and every one of the APs (or at least the ones that are visible/measurable from that measurement point). A priori, there is no restriction on the number of neither the measurement points nor the APs. The algorithms would give a ‘topology’ of the AP locations with these measurements/estimates, i.e. one that is unique up to rotation and translation and reflection. This topology can be translated unambiguously into fixed global coordinates using just three reference points, which may be three of the measurement points whose locations are unambiguously determined (e.g. those that can be fixed using GNSS positioning).

In some embodiments, the locations of the APs may be improved by iterating the above processing using the estimated locations of the APs themselves. These methods may sometimes be called estimation-maximization (EM) algorithms. In some embodiments, the above mentioned algorithms may be iterated by using the estimated locations of APs at the end of the algorithms to improve the distance estimations in the next iteration of the algorithms.

Referring to FIG. 5A, flowchart 500 represents an exemplary methodology according to some embodiments. Starting at block 502, a surveyor or mobile device may obtain measurements from at least three measurement points. In some embodiments, the measurements may include WiFi measurements. The at least three measurement points may be arbitrary locations in or around the building, and the locations of the at least 3 measurement points do not need to be known. Example processes for obtaining such measurement points may be described in any of the descriptions in FIGS. 3A, 3B, 4, and the aforementioned example algorithms. Block 502 may be implemented, for example, by transceiver 252.

At block 504, a surveyor or mobile device may compute distance measurements from the mobile device to each of the plurality of APs, at each of the at least three measurement points. In some embodiments, timing measurements may be obtained. In some embodiments, these measurements may include RTT measurements or RSSI measurements. Example processes for computing these ranging measurements may be described in any of the descriptions in FIGS. 3A, 3B, 4, and the aforementioned example algorithms. Block 504 may be implemented, for example, by processor 270.

At block 506, a set of mutual distance values may be computed to form a matrix of mutual distances between each of the plurality of APs, using the distance measurements computed in block 504. Block 506 may be consistent with the descriptions in FIG. 4 and the aforementioned algorithms. In some embodiments, the mutual distance values may be computed using principles from linear algebra or operations research. Block 506 may be implemented, for example, by processor 270.

At block 508, the locations of the plurality of APs may be determined using the computed matrix of mutual distances computed in block 506. In some embodiments, one measurement point of the at least three measurement points having a strongest measurement among the measurements is determined to be an actual location of one of the plurality of APs. For example, a measurement point that has the strongest RSSI measurement to an AP may be considered to be the actual location of that AP. As another example, a measurement point that has the shortest RTT measurement to an AP may be considered to be the actual location of that AP. In some embodiments, the locations may be fixed in an absolute geo-reference scale by determining at a least some reference locations of the AP locations using, for example, GNSS positioning techniques. In some embodiments, the locations may be fixed by determining three reference locations of the at least three measurement points using, for example, GNSS positioning techniques. Block 508 may be implemented, for example, by processor 270.

Referring to FIG. 5B, flowchart 550 represents another exemplary methodology according to some embodiments. In this example, the blocks shown in FIG. 5A may be consistent with those shown in FIG. 5B. However, flowchart 550 may employ a series of iterations that repeat the processes in blocks 502-508. Here, for example, the estimated locations determined in block 508 may be used to help determine the measurements in block 502 in a following iteration in some embodiments. In this way, the initial measurements may be more accurate, helping to refine the calculated distances. The process may end after a predetermined number of iterations, or based on a designated threshold, such as when the determined locations from one iteration to the next do not change greater than some predetermined minimal distance.

Having described multiple aspects above, an example of a computing system in which such aspects may be implemented may now be described with respect to FIG. 6. According to one or more aspects, a computer system as illustrated in FIG. 6 may be incorporated as part of a computing device, which may implement, perform, and/or execute any and/or all of the features, methods, and/or method steps described herein. For example, one or more of the processor 610, memory 635, and communications subsystems 630 may be used to implement any or all of the blocks as shown in FIGS. 5A and 5B. For example, computer system 600 may represent some of the components of a hand-held device. A hand-held device may be any computing device with an input sensory unit, such as a camera and/or a display unit. Examples of a hand-held device include but are not limited to video game consoles, tablets, smart phones, and mobile devices. In some embodiments, the system 600 is configured to implement the device 250 described above. For example, processor 610 may be used to implement some or all of Rx data processor 260, processor 270, and Tx data processor 238. Input device(s) 615 may be used to implement some or all of transceivers 252(a)-(r). Memory 635 may be used to implement memory 272, and communications subsystem 630 may be used to implement modulator 280. FIG. 6 provides a schematic illustration of one embodiment of a computer system 600 that can perform the methods provided by various other embodiments, as described herein, and/or can function as the host computer system, a remote kiosk/terminal, a point-of-sale device, a mobile device, a set-top box, and/or a computer system. FIG. 6 is meant only to provide a generalized illustration of various components, any and/or all of which may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 605 (or may otherwise be in communication, as appropriate). The hardware elements may include one or more processors 610, including without limitation one or more general-purpose processors and/or one or more special-purpose processors (such as digital signal processing chips, graphics acceleration processors, and/or the like); one or more input devices 615, which can include without limitation a camera, a mouse, a keyboard and/or the like; and one or more output devices 620, which can include without limitation a display unit, a printer and/or the like.

The computer system 600 may further include (and/or be in communication with) one or more non-transitory storage devices 625, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 600 might also include a communications subsystem 630, which can include without limitation a modem, a network card (wireless or wired), an infrared communication device, a wireless communication device and/or chipset (such as a Bluetooth® device, an 802.11 device, a WiFi device, a WiMax device, cellular communication facilities, etc.), and/or the like. The communications subsystem 630 may permit data to be exchanged with a network (such as the network described below, to name one example), other computer systems, and/or any other devices described herein. In many embodiments, the computer system 600 may further comprise a non-transitory working memory 635, which can include a RAM or ROM device, as described above.

The computer system 600 also can comprise software elements, shown as being currently located within the working memory 635, including an operating system 640, device drivers, executable libraries, and/or other code, such as one or more application programs 645, which may comprise computer programs provided by various embodiments, and/or may be designed to implement methods, and/or configure systems, provided by other embodiments, as described herein. Merely by way of example, one or more procedures described with respect to the method(s) discussed above, for example as described with respect to FIG. 5A or 5B, might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 625 described above. In some cases, the storage medium might be incorporated within a computer system, such as computer system 600. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Some embodiments may employ a computer system (such as the computer system 600) to perform methods in accordance with the disclosure. For example, some or all of the procedures of the described methods may be performed by the computer system 600 in response to processor 610 executing one or more sequences of one or more instructions (which might be incorporated into the operating system 640 and/or other code, such as an application program 645) contained in the working memory 635. Such instructions may be read into the working memory 635 from another computer-readable medium, such as one or more of the storage device(s) 625. Merely by way of example, execution of the sequences of instructions contained in the working memory 635 might cause the processor(s) 610 to perform one or more procedures of the methods described herein, for example one or more of the elements of the method described with respect to any of FIG. 5A or 5B.

The terms “machine-readable medium” and “computer-readable medium,” as used herein, refer to any medium that participates in providing data that causes a machine to operate in a specific fashion. In an embodiment implemented using the computer system 600, various computer-readable media might be involved in providing instructions/code to processor(s) 610 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 625. Volatile media include, without limitation, dynamic memory, such as the working memory 635. Transmission media include, without limitation, coaxial cables, copper wire and fiber optics, including the wires that comprise the bus 605, as well as the various components of the communications subsystem 630 (and/or the media by which the communications subsystem 630 provides communication with other devices). Hence, transmission media can also take the form of waves (including without limitation radio, acoustic and/or light waves, such as those generated during radio-wave and infrared data communications).

In one or more examples, the functions described may be implemented in hardware, software, firmware, or any combination thereof. If implemented in software, the functions may be stored on or transmitted over as one or more instructions or code on a computer-readable medium. Computer-readable media may include computer data storage media. Data storage media may be any available media that can be accessed by one or more computers or one or more processors to retrieve instructions, code and/or data structures for implementation of the techniques described in this disclosure. “Data storage media” as used herein refers to manufactures and does not refer to transitory propagating signals. By way of example, and not limitation, such computer-readable media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The code may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware stored on computer-readable media.

Various examples have been described. These and other examples are within the scope of the following claims.

What is claimed is:

1. A method for determining locations of a plurality of access points (APs), the method comprising:
a) obtaining measurements from at least 3 measurement points using a mobile device, wherein locations of the at least 3 measurement points are unknown and are at different locations;
b) computing distance measurements from the mobile device to each of the plurality of APs, at each of the at least 3 measurement points, using the measurements;
c) computing a set of mutual distance values in a matrix of mutual distances between each of the plurality of APs, using the distance measurements; and
d) determining the locations of the plurality of APs using the computed matrix of mutual distances, relative to the at least 3 measurement points.

2. The method of claim 1, wherein the at least 3 measurement points comprises 3 reference points whose locations are unambiguously determined, the method further comprising e) determining global locations of the plurality of APs using the computed matrix of mutual distances and the 3 reference points.

3. The method of claim 1, wherein the measurements from each of the at least 3 measurement points comprise ranging information associated with each of the plurality of APs.

4. The method of claim 1, wherein computing the distance measurements comprise at least one of computing roundtrip times from the mobile device to each of the plurality of APs, and estimating the distance measurements based on signal strength to each of the plurality of APs from the mobile device.

5. The method of claim 1, wherein a measurement point of the at least 3 measurement points having a strongest measurement among the measurements is determined to be an actual location of one of the plurality of APs.

6. The method of claim 1, further comprising repeating steps a) through d) in an iterative process, wherein the measurements obtained in step a) are based on the determined locations of the plurality of APs in step d).

7. An apparatus for determining locations of a plurality of access points (APs), the apparatus comprising:
a receiver configured to a) obtain measurements from at least 3 measurement points using a mobile device, wherein locations of the at least 3 measurement points are unknown and are at different locations; and
a processor configured to:
b) compute distance measurements from the mobile device to each of the plurality of APs, at each of the at least 3 reference points, using the measurements;
c) compute a set of mutual distance values in a matrix of mutual distances between each of the plurality of APs, using the distance measurements; and
d) determine the locations of the plurality of APs using the computed matrix of mutual distances, relative to the at least 3 measurement points.

8. The apparatus of claim 7, wherein the at least 3 measurement points comprises 3 reference points whose locations are unambiguously determined, and wherein the processor is further configured to e) determine global locations of the plurality of APs using the computed matrix of mutual distances and the 3 reference points.

9. The apparatus of claim 7, wherein the measurements from each of the at least 3 measurement points comprises ranging information associated with each of the plurality of APs.

10. The apparatus of claim 7, wherein the processor is further configured to compute roundtrip times from the mobile device to each of the plurality of APs or estimate the distance measurements based on signal strength to each of the plurality of APs from the mobile device to the compute distance measurements from the mobile device.

11. The apparatus of claim 7, wherein a measurement point of the at least 3 reference points having a strongest measurement among the measurements is determined to be an actual location of one of the plurality of APs.

12. The apparatus of claim 7, wherein the receiver and the processor are further configured to repeat steps a) through d) in an iterative process, wherein the measurements obtained in step a) are based on the determined locations of the plurality of APs in step d).

13. An apparatus for determining locations of a plurality of access points (APs), the apparatus comprising:
means for a) obtaining measurements from at least 3 measurement points, wherein locations of the at least 3 reference points are unknown and are at different locations;
means for b) computing distance measurements from the apparatus to each of the plurality of APs, at each of the at least 3 measurement points, using the measurements;
means for c) computing a set of mutual distance values in a matrix of mutual distances between each of the plurality of APs, using the distance measurements; and
means for d) determining the locations of the plurality of APs using the computed matrix of mutual distances, relative to the at least 3 measurement points.

14. The apparatus of claim 13, wherein the at least 3 measurement points comprises 3 reference points whose locations are unambiguously determined, the apparatus further comprising e) means for determining global locations of the plurality of APs using the computed matrix of mutual distances and the 3 reference points.

15. The apparatus of claim 13, wherein the measurements from each of the at least 3 measurement points comprises ranging information associated with each of the plurality of APs.

16. The apparatus of claim 13, wherein the means for computing the distance measurements comprises at least one of means for computing roundtrip times from the apparatus to each of the plurality of APs, and means for estimating the distance measurements based on signal strength to each of the plurality of APs from the apparatus.

17. The apparatus of claim 13, wherein a measurement point of the at least 3 reference points having a strongest measurement among the measurements is determined to be an actual location of one of the plurality of APs.

18. The apparatus of claim 13, further comprising means for repeating steps a) through d) in an iterative process, wherein the measurements obtained in step a) are based on the determined locations of the plurality of APs in step d).

19. A non-transitory processor-readable medium comprising processor-readable instructions configured to cause a processor to:
a) obtain measurements from at least 3 measurement points, wherein locations of the at least 3 measurement points are unknown and are at different locations;
b) compute distance measurements from a mobile device to each of a plurality of APs, at each of the at least 3 measurement points, using the measurements;
c) compute a set of mutual distance values in a matrix of mutual distances between each of the plurality of APs, using the distance measurements; and
d) determine the locations of the plurality of APs using the computed matrix of mutual distances, relative to the at least 3 measurement points.

20. The non-transitory processor-readable medium of claim 19, wherein the at least 3 measurement points comprises 3 reference points whose locations are unambiguously determined, and wherein the instructions are further configured to cause the processor to e) determine global locations of the plurality of APs using the computed matrix of mutual distances and the 3 reference points.

21. The non-transitory processor-readable medium of claim 19, wherein the measurements from each of the at least 3 measurement points comprises ranging information associated with each of the plurality of APs.

22. The non-transitory processor-readable medium of claim 19, wherein the instructions are further configured to cause the processor to compute roundtrip times from the mobile device to each of the plurality of APs or estimate the distance measurements based on signal strength to each of the plurality of APs from the mobile device to compute the distance measurements from the mobile device.

23. The non-transitory processor-readable medium of claim 19, wherein the instructions are further configured to cause the processor to repeat steps a) through d) in an iterative process, wherein the measurements obtained in step a) are based on the determined locations of the plurality of APs in step d).
